(19) United States
(12) Patent Application Publication
(10) Pub. No.: US 2020/0122488 A1
(43) Pub. Date: Apr. 23, 2020

(54) HEATED PRESSURE ROLLER LAMINATORS

(71) Applicant: Hewlett-Packard Development Company, L.P., Spring, TX (US)

(72) Inventors: Richard Lee Brinkly, Vancouver, WA (US); Marc Elkins, Vancouver, WA (US)

(73) Assignee: Hewlett-Packard Development Company, L.P., Soring, TX (US)

(21) Appl. No.: 16/614,979

(22) PCT Filed: Jul. 10, 2017
(86) PCT No.: PCT/US2017/041386

§ 371 Date: Nov. 19, 2019

(51) Int. Cl. B41J 11/00; B41M 7/00

(52) U.S. Cl. CPC B41J 11/002; B41M 7/009; B41M 7/0027

(57) ABSTRACT

In one example, a heated pressure roller laminator can include lamination device, comprising: a heated pressure roller comprising a cylinder pressure roller and a heated belt roller to: receive a plurality of film materials at an input of the heated pressure roller and apply pressure and heat to the plurality of film materials to generate a laminate material.

### BACKGROUND

Inkjet printers can deposit quantities of printing fluid onto a printable media (e.g., paper, plastic, etc.). In some examples, inkjet printers can create a curl and/or cockle in the printed media when the printing fluid droplets are deposited by the inkjet printer. In some examples, a number of physical properties of the printable media can be changed when the printing fluid droplets are deposited by the inkjet printer. For example, the stiffness of the printable media can be changed when the printing fluid droplets are deposited by the inkjet printer. The curl, cockle, and/or other physical properties that change due to the printing fluid droplets can make document finishing processes difficult.

### BRIEF DESCRIPTION OF THE DRAWINGS

FIG. 1 illustrates an example heated pressure roller laminator consistent with the present disclosure.

FIG. 2 illustrates an example system for a heated pressure roller laminator consistent with the present disclosure.

FIG. 3 illustrates an example printing device for a heated pressure roller laminator consistent with the present disclosure.

FIG. 4 illustrates an example heated pressure roller laminator consistent with the present disclosure.

### DETAILED DESCRIPTION

A number of systems and devices for a heated pressure roller laminator are described herein. In some examples, a heated pressure roller laminator can include a heated pressure roller comprising a cylinder pressure roller and a heated belt roller to receive a plurality of film materials at an input of the heated pressure roller and apply pressure and heat to the plurality of film materials to generate a laminate material. The heated pressure roller laminators described herein can be positioned within an inkjet printing device. The heated pressure roller laminators described herein can be utilized to increase drying of partially dried inkjet media with a first set of settings and can be utilized to generate a laminate material with a second set of settings. Thus, the heated pressure roller laminators described herein can be utilized to provide the multiple functions of laminating and drying for an inkjet printing device.

The inkjet printing device can include a print zone to deposit a printing fluid on a print media. The print zone of the inkjet printing device can deposit the printing fluid to generate partially dried inkjet media. In some examples, the partially dried inkjet media can provide difficulties when stacking, aligning, and/or finishing. For example, the partially dried inkjet media can have distorted properties such as a curl, a cockle, a reduction in stiffness, increased surface roughness, extruding or protruding fibers from the surface, misaligned fibers, and/or increased sheet to sheet friction of the media. In some examples, these distorted properties can be caused by printing fluid deposited on the media and the media absorbing the printing fluid. For example, the printing fluid can be in a liquid state that can be absorbed by a media such as paper. In this example, the liquid state of the printing fluid can cause the distorted properties of the media in a similar way that other liquids may distort the properties of the media.

The heated pressure roller laminators can be positioned within an inkjet printing device. As described herein, the heated pressure rollers of the inkjet printing device can increase a drying time of the partially dried inkjet media and remove distorted properties of the partially dried inkjet media utilizing a first set of settings. In some examples, the first set of settings can include a first pressure setting and/or a first heat setting. For example, the set of settings can adjust the heated pressure roller to apply a particular level of pressure and apply a particular level of heat to the partially dried inkjet media. In some examples, the heated pressure roller can be adjusted to utilize a second set of settings to generate a laminate material from a plurality of laminate film materials. For example, the second set of settings can adjust the heated pressure roller to apply a second level of pressure and/or a second level of heat to melt and/or bind the laminate film materials to generate a laminate material. As used herein, the laminate material can include a substrate that is laminated on each side of the substrate.

The heated pressure roller laminators described herein can be dual purpose based on the settings of the heated pressure roller. For example, the same heated pressure roller can be utilized to increase drying time and/or remove distorted properties of partially dried inkjet media utilizing a first set of settings and can also be utilized to generate laminate material utilizing a second set of settings. The heated pressure roller laminators can utilize a heated belt roller to apply heat to the partially dried inkjet media and/or to apply heat to the laminate film materials. The heated belt roller can include a flexible material that can flex to a shape of the media passing through the heated pressure roller. The heated belt roller can increase a contact surface between the heated belt roller and the media compared to cylinder rollers. In some examples, the heated belt roller can more evenly apply heat and increase the total amount of energy transferred to the media by increasing the contact surface between the heated belt roller and the media, which can provide a more evenly melting and/or binding of the laminate material compared to cylinder rollers.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

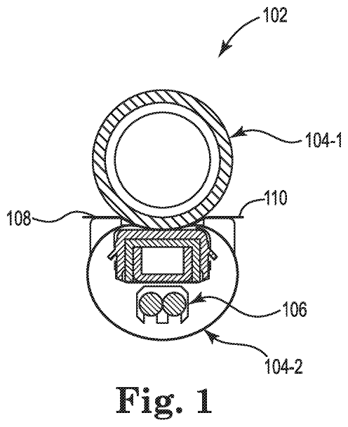

FIG. 1 illustrates an example heated pressure roller laminator 102 consistent with the present disclosure. In some examples, the heated pressure roller laminator 102 can be utilized as a component of a conditioner for partially dried inkjet media generated by a print zone of a printing device as described herein. In some examples, the heated pressure roller laminator 102 can apply pressure on a first side of substrate 108 and apply heat on a second side of the substrate 108. As used herein, the substrate 108 can include partially dried inkjet media, film material, substrate between film material, among other substrates that can be fed through a heated pressure roller. For example, the substrate 108 can include a print media such as paper positioned between a first laminate film material on a first side of the print media and a second laminate film material on a second side of the print media.

In some examples, the heated pressure roller laminator 102 can increase drying and/or evaporation of printing fluid applied to partially dried inkjet media when utilizing a first set of settings and can melt or bind film materials to generate a laminate material when utilizing a second set of settings. For example, the heated pressure roller laminator 102 can receive the substrate 108 that includes print media and/or a plurality of film materials at an input of the heated pressure roller laminator 102. In this example, the heated pressure roller laminator 102 can melt and/or bind the plurality of film materials around the print media to generate a laminate material 110. As used herein, the laminate material 110 can be a laminated substrate. For example, the laminate material 110 can be a print media that is enclosed between laminate film material bound together to protect the print media.

In some examples, the heated pressure roller laminator 102 can receive the substrate 108 at an input of the heated pressure roller laminator 102 (e.g., illustrated as left side as referenced in FIG. 1). In some examples, the heated pressure roller laminator 102 can include a pressure roller 104-1 to apply pressure on a first side of the substrate 108 (e.g., illustrated as top side as referenced in FIG. 1). In some examples, the pressure roller 104-1 can be coupled to a spring mechanism to apply pressure on the heated belt roller 104-2 that includes a heat source. In some examples, the pressure roller 104-1 can be a cylinder roller. As used herein, a cylinder roller can be a cylinder shaped roller that has an exterior flexible coating with a substantially solid and/or non-flexible core to apply pressure to the first side of the substrate 108. In some examples, the pressure roller 104-1 can include a contact zone. The contact zone can be an area on the pressure roller 104-1-1 that interacts with the first side of the substrate 108. In some examples, the contact zone can correspond to a pressure platen positioned within a heated belt roller 104-2.

In some examples, the heated belt roller 104-2 can apply heat to a second side of the substrate (e.g., illustrated as bottom side as referenced in FIG. 1). In some examples, the heated belt roller 104-2 can include a heat source 106. In some examples, the heat source 106 can include a halogen heat source. In some examples, the heat source 106 can be a resistive element in contact with the transfer belt between a top surface of the platen and an interior surface of the transfer belt. In some examples, the heat source 106 can generate heat that is transferred to a heat transfer belt of the heated belt roller 104-2. In some examples, the heat transfer belt can rotate around the heated belt roller 104-2 and contact the second side of the substrate 108 within the pressure platen.

As described herein, the transfer belt of the heated belt roller 104-2 can be a flexible material that can form to a shape of the substrate 108 as it passes between the pressure roller 104-1 and the heated belt roller 104-2. Since the heated belt roller 104-2 utilizes a flexible transfer belt, the heated belt roller 104-2 can have a greater contact surface area compared to cylinder roller such as the pressure roller 104-1. In some previous lamination systems, two or more cylinder rollers that are heated can be utilized to provide pressure and heat to a substrate such as substrate 108. However, utilizing two or more cylinder rollers can provide uneven heat and/or uneven pressure within a relatively smaller contact zone on the substrate, which can cause defects in a generated lamination material and/or can restrict a speed of lamination material generation. In some previous lamination systems, a fuser of a laser printing device can be utilized to generate a laminate material.

The fuser of the laser printing device can include two cylinder rollers that can be utilized to melt or bind polymer material such as toner material of a laser printing device to a print media. The fuser of the laser printing device can be different than a heated pressure roller 102 as described herein. For example, the fuser can utilize two heated cylinder rollers to melt the polymer material during a normal printing process for the laser printing device and also be utilized to melt the polymer material of lamination film materials. As described herein, the fuser of a laser printing device can provide relatively uneven heat and/or pressure to a relatively larger contact zone to a substrate compared to the heated pressure roller 102.

In contrast, utilizing a heated belt roller 104-2 and corresponding pressure roller 104-1 can provide more evenly distributed heat and/or pressure to the substrate 108. For example, the substrate 108 can include portions that are relatively thinner and portions that are relatively thicker. In this example, the substrate 108 can include a plurality of laminate film materials surrounding a media. In this example, the plurality of laminate film materials can extend beyond the borders of the media. In this example, the area of the media surrounded by the laminate film materials can be relatively thicker than the area surrounding the border of the media. In this example, the transfer belt of the heated belt roller 104-2 can form to the shape of the thicker area and/or the thinner area to provide more contact surface at each area compared to previous lamination systems that utilize multiple cylinder rollers. Thus, the heated pressure roller 102 laminator can generate a more consistent laminate material 110 from the substrate 108 compared to these previous lamination systems.

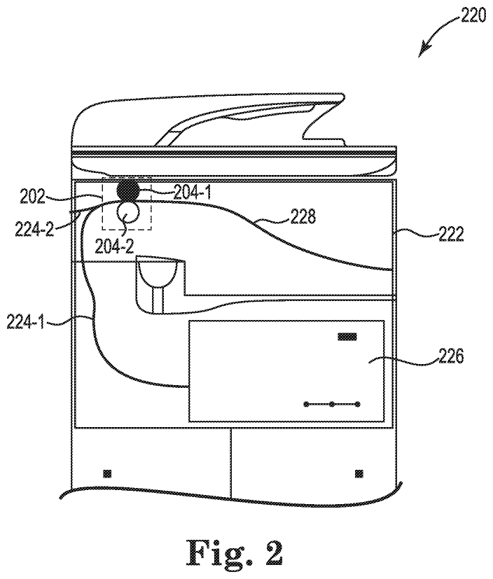

FIG. 2 illustrates an example system 220 for a heated pressure roller laminator 202 consistent with the present disclosure. In some examples, the system 220 can illustrate an inkjet printing device. For example, the system 220 can include a print zone 226 that can deposit printing fluid on a print media to generate partially dried inkjet media as described herein. The system 220 can illustrate an inkjet printing device with multiple inputs 224-1, 224-2 to a heated pressure roller laminator 202 and a single output 228.

As described herein, the system 220 can include a heated pressure roller laminator 202 within an inkjet printing device. The heated pressure roller laminator 202 can include a pressure roller and a heated belt roller. The heated pressure roller laminator 202 can be the same or similar device as the heated pressure roller laminator 102 as referenced in FIG. 1. That is, the heated pressure roller laminator 202 can include a first roller 204-1 that is a cylinder pressure roller and a second roller 204-2 that is a heated belt roller.

In some examples, the heated pressure roller laminator 202 can include a first input 224-1 coupled to the print zone 226 of the inkjet printing device. In some examples, the first input 224-1 can be utilized to receive partially dried inkjet media from the print zone 226. For example, the print zone 226 can deposit printing fluid to print media (e.g., paper, etc.) and the heated pressure roller laminator 202 can receive the partially dried inkjet media from the print zone 226 via the first input 224-1. As described herein, the heated pressure roller laminator 202 can be utilized to increase drying or evaporation of the printing fluid deposited on the partially dried inkjet media. In addition, the heated pressure roller laminator 202 can be utilized to remove distorted properties of the partially dried inkjet media due to the deposited printing fluid deposited at the print zone 226. For example, the heated pressure roller laminator 202 can apply heat and pressure to the partially dried inkjet media to increase a drying time and/or remove distorted properties of the partially dried inkjet media.

In some examples, the heated pressure roller laminator 202 can utilize a first set of settings when the heated pressure roller laminator 202 is to receive partially dried inkjet media from the print zone 226. For example, a user interface coupled to the system 220 can be utilized to alter settings of the heated pressure roller laminator 202. In this example, the user interface can be utilized to select a printing function. In this example, the user interface can alter the settings of the heated pressure roller laminator 202 to the first set of settings to receive the partially dried inkjet media from the first input 224-1. In some examples, the first set of settings can include a first pressure setting, a first speed setting, and/or a first temperature setting to increase the drying of the partially dried inkjet media and/or remove distorted properties of the partially dried inkjet media. In some examples, the first pressure setting can be approximately 1.5 kilograms per centimeter squared (kg/cm²). In some examples, the first speed setting can be within a range between 170 millimeters per second (mm/s) and 300 mm/s. In some examples, the first temperature setting can be a temperature between 100 degrees Celsius. (C) and 150° C. In some examples, the heated pressure roller laminator 202 can include an output 228. The output 228 can be coupled to a number of finishers (e.g., stapler, folder, etc.). As described further herein, the heated pressure roller laminator 202 can include a plurality of outputs (not shown).

In some examples, the heated pressure roller laminator 202 can include a second input 224-2. In some examples, the second input 224-2 can be coupled to a bypass tray of the inkjet printing device. In some examples, the second input 224-2 can bypass the print zone 226 of the inkjet printing device. Bypassing the print zone 226 can prevent the substrate from having to pass through a number of additional rollers, which can alter a position of the media and/or laminate film materials of the substrate. For example, the number of additional rollers from the print zone 226 to the first input 224-1 can alter a position of the laminate film materials and generate a laminate material that is not centered around the media positioned between the laminate material.

In some examples, the heated pressure roller laminator 202 can utilize a second set of settings when the heated pressure roller laminator 202 is to receive a substrate (e.g., substrate 108 as referenced in FIG. 1, etc.) via the second input 224-2. In some examples, the second set of settings can include a second pressure setting, a second speed setting, and/or a second temperature setting to melt or bind the laminate film materials together. In some examples, the second pressure setting can be approximately 1.0 kg/cm². In some examples, the second speed setting can be a speed between 20 mm/s and 150 mm/s. In some examples, the second temperature setting can be between 150° C. and 195° C. In one example, a particular temperature and pressure can melt an adhesive applied to the laminate film materials. In this example, the melted adhesive can be utilized with the applied pressure to bind the laminate film materials together with a permanent or semi-permanent bond.

In some examples, the second set of settings can be different than the first set of settings. For example, the temperature setting of the second set of settings can be relatively higher than the first set of settings. In this example, the pressure setting of the second set of settings can be relatively higher than the first set of settings. In this example, the speed settings can be relatively slower than the speed setting of the first set of settings. In some examples, the second set of settings can be based on the substrate utilized. For example, the second set of settings can be adjusted based on a thickness or type of laminate film material, a thickness or type of media utilized, and/or other features of the substrate that may affect the melting or binding properties of the laminate film material. In some examples, the substrate provided to the heated pressure roller laminator 202 can be sent to the output 228 and/or an output tray of the printing device.

In some examples, the system 220 can utilize a heated pressure roller laminator 202 as a dual function roller. For example, the heated pressure roller laminator 202 can be utilized for drying and/or removing distorted properties of partially dried inkjet media when a first set of settings are utilized as well as for generating a laminate material from laminate film materials when a second set of settings are utilized.

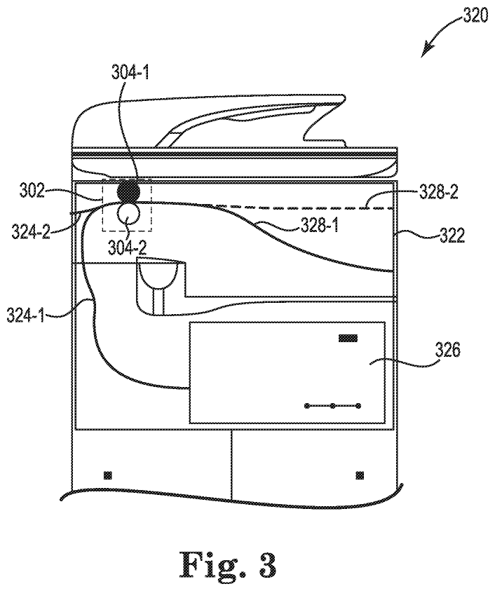

FIG. 3 illustrates an example printing device for a heated pressure roller laminator consistent with the present disclosure. In some examples, the system 320 can illustrate an inkjet printing device. For example, the system 320 can include a print zone 326 that can deposit printing fluid on a print media to generate partially dried inkjet media as described herein. The system 320 can illustrate an inkjet printing device with multiple inputs 324-1, 324-2 to a heated pressure roller laminator 302 and multiple outputs 328-1, 328-2.

In some examples, the system 320 can include a heated pressure roller laminator 302 within an inkjet printing device. As described herein, the heated pressure roller laminator 302 can include a pressure roller and a heated belt roller. The heated pressure roller laminator 302 can be the same or similar device as the heated pressure roller laminator 102 as referenced in FIG. 1 and/or heated pressure roller laminator 202 as referenced in FIG. 2. That is, the heated pressure roller laminator 302 can include a first roller 304-1 that is a cylinder pressure roller and a second roller 304-2 that is a heated belt roller.

In some examples, the heated pressure roller laminator 302 can include a first input 324-1 coupled to the print zone 326 of the inkjet printing device. In some examples, the first input 324-1 can be utilized to receive partially dried inkjet media from the print zone 326. For example, the print zone 326 can deposit printing fluid to print media (e.g., paper, etc.) and the heated pressure roller laminator 302 can receive the partially dried inkjet media from the print zone 326 via the first input 224-1. As described herein, the heated pressure roller laminator 302 can be utilized to increase drying or evaporation of the printing fluid deposited on the partially dried inkjet media. In addition, the heated pressure roller laminator 302 can be utilized to remove distorted properties of the partially dried inkjet media due to the deposited printing fluid deposited at the print zone 326. For example, the heated pressure roller laminator 302 can apply heat and pressure to the partially dried inkjet media to increase a drying time and/or remove distorted properties of the partially dried inkjet media.

In some examples, the heated pressure roller laminator 302 can utilize a first set of settings when the heated pressure roller laminator 302 is to receive partially dried inkjet media from the print zone 326. For example, a user interface coupled to the system 320 can be utilized to alter settings of the heated pressure roller laminator 302. In this example, the user interface can be utilized to select a printing function. In this example, the user interface can alter the settings of the heated pressure roller laminator 302 to the first set of settings to receive the partially dried inkjet media from the first input 324-1. In some examples, the first set of settings can include a first pressure setting, a first speed setting, and/or a first temperature setting to increase the drying of the partially dried inkjet media and/or remove distorted properties of the partially dried inkjet media. In some examples, the heated pressure roller laminator 302 can include an output a first 328-1. The first output 328-1 can be coupled to a number of finishers (e.g., stapler, folder, etc.). For example, the first output 328-1 can be coupled to a finisher for folding the dried partially dried inkjet media from the heated pressure roller laminator 302 when the heated pressure roller laminator 302 is utilizing the first set of settings.

In some examples, the heated pressure roller laminator 302 can include a second input 324-2. In some examples, the second input 324-2 can be coupled to a bypass tray of the inkjet printing device. In some examples, the second input 324-2 can bypass the print zone 326 of the inkjet printing device. Bypassing the print zone 326 can prevent the substrate from having to pass through a number of additional rollers, which can alter a position of the media and/or laminate film materials of the substrate. For example, the number of additional rollers from the print zone 326 to the first input 324-1 can alter a position of the laminate film materials and generate a laminate material that is not centered around the media positioned between the laminate material.

In some examples, the heated pressure roller laminator 302 can utilize a second set of settings when the heated pressure roller laminator 302 is to receive a substrate (e.g., substrate 108 as referenced in FIG. 1, etc.) via the second input 324-2. In some examples, the second set of settings can include a second pressure setting, a second speed setting, and/or a second temperature setting to melt or bind the laminate film materials together. For example, a particular temperature and pressure can melt an adhesive applied to the laminate film materials. In this example, the melted adhesive can be utilized with the applied pressure to bind the laminate film materials together with a permanent or semi-permanent bond.

In some examples, the second set of settings can be different than the first set of settings. For example, the temperature setting of the second set of settings can be relatively higher than the first set of settings. In this example, the pressure setting of the second set of settings can be relatively higher than the first set of settings. In this example, the speed settings can be relatively slower than the speed setting of the first set of settings. In some examples, the second set of settings can be based on the substrate utilized. For example, the second set of settings can be adjusted based on a thickness or type of laminate film material, a thickness or type of media utilized, and/or other features of the substrate that may affect the melting or binding properties of the laminate film material. In some examples, the substrate provided to the heated pressure roller laminator 302 can be sent to a second output 328-2 and/or an output tray of the printing device. In some examples, the second output 328-2 can bypass the number of finishers coupled to the first output 328-1. Bypassing the number of finishers coupled to the first output 328-1 can avoid damage to the laminate material generated when the substrate passes through the heated pressure roller laminator 302.

In some examples, the system 320 can utilize a heated pressure roller laminator 302 as a dual function roller. For example, the heated pressure roller laminator 302 can be utilized for drying and/or removing distorted properties of partially dried inkjet media when a first set of settings are utilized as well as for generating a laminate material from laminate film materials when a second set of settings are utilized.

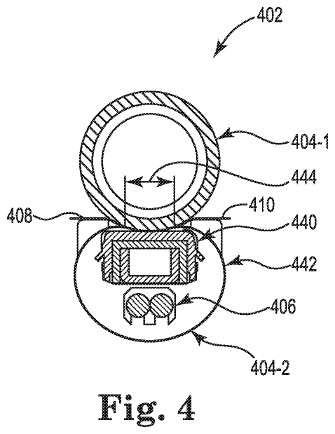

FIG. 4 illustrates an example heated pressure roller laminator 402 consistent with the present disclosure. In some examples, the heated pressure roller laminator 402 may be the same heated pressure roller laminator as described herein (e.g., heated pressure roller 102 as referenced in FIG. 1, heated pressure roller 202 as referenced in FIG. 2, heated pressure roller 302 as referenced in FIG. 3, etc.). In some examples, the heated pressure roller laminator 402 can be utilized as a component of a conditioner for partially dried inkjet media generated by a print zone of a printing device as described herein.

In some examples, the heated pressure roller laminator 402 can apply pressure on a first side of substrate 408 and apply heat on a second side of the substrate 408. As used herein, the substrate 408 can include partially dried inkjet media, film material, substrate between film material, among other substrates that can be fed through a heated pressure roller. For example, the substrate 408 can include a print media such as paper positioned between a first laminate film material on a first side of the print media and a second laminate film material on a second side of the print media.

In some examples, the heated pressure roller laminator 402 can increase drying and/or evaporation of printing fluid applied to partially dried inkjet media when utilizing a first set of settings and can melt or bind film materials (e.g., laminate film material, etc.) to generate a laminate material when utilizing a second set of settings. For example, the heated pressure roller laminator 402 can receive the substrate 408 that includes print media and/or a plurality of film materials at an input of the heated pressure roller laminator 402. In this example, the heated pressure roller laminator 402 can melt and/or bind the plurality of film materials around the print media to generate a laminate material 410. As used herein, the laminate material 410 can be a laminated substrate. For example, the laminate material 410 can be a print media that is enclosed between laminate film material bound together to protect the print media.

In some examples, the heated pressure roller laminator 402 can receive the substrate 108 at an input of the heated pressure roller laminator 402 (e.g., illustrated as left side as referenced in FIG. 4). In some examples, the heated pressure roller laminator 402 can include a pressure roller 404-1 to apply pressure on a first side of the substrate 408 (e.g., illustrated as top side as referenced in FIG. 4). In some examples, the pressure roller 404-1 can be a cylinder roller. As used herein, a cylinder roller can be a cylinder shaped roller that has an exterior flexible coating with a substantially solid and/or non-flexible core to apply pressure to the first side of the substrate 408. In some examples, the pressure roller 404-1 can include a contact zone 444. The contact zone 444 can be an area on the pressure roller 404-1-1 that interacts with the first side of the substrate 408. In some examples, the contact zone 444 can correspond to a pressure platen 440 positioned within a heated belt roller 104-2.

In some examples, the heated belt roller 404-2 can apply heat to a second side of the substrate 408 (e.g., illustrated as bottom side as referenced in FIG. 4). In some examples, the heated belt roller 404-2 can include a heat source 406. In some examples, the heat source 406 can include a halogen heat source or other type of heat source described herein. In some examples, the heat source 406 can generate heat that is transferred to a heat transfer belt 442 of the heated belt roller 404-2. In some examples, the heat transfer belt 442 can rotate around the heated belt roller 404-2 and contact the second side of the substrate 408 within the pressure platen 440.

As described herein, the transfer belt 442 of the heated belt roller 404-2 can be a flexible material that can form to a shape of the substrate 408 as the substrate 408 passes between the pressure roller 404-1 and the heated belt roller 404-2. Since the heated belt roller 404-2 utilizes a flexible transfer belt 442, the heated belt roller 404-2 can have a greater contact surface area compared to cylinder roller such as the pressure roller 404-1. In some previous lamination systems, two or more cylinder rollers that are heated can be utilized to provide pressure and heat to a substrate such as substrate 408. However, utilizing two or more cylinder rollers can provide uneven heat and/or uneven pressure on the substrate, which can cause defects in a generated lamination material and/or can restrict a speed of lamination material generation.

In contrast, utilizing a heated belt roller 404-2 and corresponding pressure roller 404-1 can provide more evenly distributed heat and/or pressure to the substrate 408. For example, the substrate 408 can include portions that are relatively thinner and portions that are relatively thicker. In this example, the substrate 408 can include a plurality of laminate film materials surrounding a media. In this example, the plurality of laminate film materials can extend beyond the borders of the media. In this example, the area of the media surrounded by the laminate film materials can be relatively thicker than the area surrounding the border of the media. In this example, the transfer belt 440 of the heated belt roller 404-2 can form to the shape of the thicker area and/or the thinner area to provide more contact surface at each area compared to previous lamination systems that utilize multiple cylinder rollers. Thus, the heated pressure roller laminator 402 can generate a more consistent laminate material 410 from the substrate 408 compared to these previous lamination systems.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed:

1. A lamination device, comprising:
a heated pressure roller comprising a cylinder pressure roller and a heated belt roller to:
receive a plurality of film materials at an input of the heated pressure roller; and
apply pressure and heat to the plurality of film materials to generate a laminate material.

2. The lamination device of claim 1, wherein the heated pressure roller receives a media between the plurality of film materials.

3. The lamination device of claim 2, wherein the laminate material includes the media sealed between the plurality of film materials.

4. The lamination device of claim 1, wherein the lamination device is within a printing device.

5. The lamination device of claim 1, wherein pressure roller applies pressure on a pressure platen of the heated belt roller.

6. A system, comprising:
a heated pressure roller positioned within a printing device, wherein the heated pressure roller includes a heated belt roller;
a first input of the heated pressure roller to receive partially dried inkjet media from a print zone of the printing device; and
a second input of the heated pressure roller to receive a plurality of lamination film materials and substrate material, wherein the heated pressure roller creates a bond between the plurality of lamination film materials.

7. The system of claim 6, wherein the heated pressure roller comprises a first roller coupled to a spring to apply pressure on a second roller that includes a heat source.

8. The system of claim 6, wherein the first input of the heated pressure roller is coupled to a first media pathway coupled to a first media tray.

9. The system of claim 8, wherein the second input of the heated pressure roller is coupled to a second media pathway coupled to a second media tray.

10. The system of claim 6, wherein the heated pressure roller utilizes a first setting when the heated pressure roller is to receive the partially dried inkjet media.

11. The system of claim 10, wherein the heated pressure roller utilizes a second setting when the heated pressure roller is to receive the plurality of lamination film materials and substrate material.

12. A printing device, comprising:
a heated pressure roller that includes:
a heated belt roller to apply heat;
a cylinder pressure roller to apply pressure to the heated belt roller;
a first input coupled to a print media pathway; and
a second input coupled to a media input tray;
a user interface to:
alter a setting of the heated pressure roller to a first state to receive partially dried inkjet media from the print media pathway; and
alter the setting of the heated pressure roller to a second state to receive a plurality of lamination film materials and substrate material from the media input tray.

13. The printing device of claim 12, wherein first state provides a first quantity of heat and pressure to the partially dried inkjet media to increase drying of printing fluid applied to the partially dried inkjet media.

14. The printing device of claim 13, wherein the second state provides a second quantity of heat and pressure to the plurality of lamination film materials and substrate to create a bond between the plurality of lamination film materials.

15. The printing device of claim 14, wherein the second quantity of heat and pressure is greater than the first quantity of heat and pressure.
